(19) United States
(12) Patent Application Publication
(10) Pub. No.: US 2026/0145107 A1
(43) Pub. Date: May 28, 2026

(54) WATER SEPARATOR FOR SEPARATING WATER FROM A FLUID FLOW

(71) Applicant: MANN+HUMMEL GmbH, Ludwigsburg (DE)

(72) Inventors: Andreas WEBER, Freiberg (DE); Tobias WÖRZ, Leutenbach (DE); Ettore NOCERA, Besigheim (DE); Thomas GREIN, Eggenstein-Leopoldshafen (DE); Matthias TESCHNER, Ludwigsburg (DE); Alexander KORN, Güglingen (DE); Pius TRAUTMANN, Stuttgart (DE); Thomas SCHLEIDEN, Oberstenfeld (DE); Christof MANGOLD, Korntal-Münchingen (DE)

(21) Appl. No.: 19/410,294

(22) Filed: Dec. 5, 2025

Related U.S. Application Data
(63) Continuation of application No. PCT/EP2024/064615, filed on May 28, 2024.

(30) Foreign Application Priority Data
Jun. 13, 2023 (DE) 10 2023 115 366.8

(51) Int. Cl. B01D 45/16; B01D 45/08; H01M 8/04119

(52) U.S. Cl. CPC B01D 45/16; B01D 45/08; H01M 8/04164

(57) ABSTRACT

A water separator for separating water from a fluid flow includes at least a first separation stage with a first flow-conducting region, which is connected to a fluid conduit. In the fluid conduit, a coarse water separator is arranged. A separation region is connected to a water outlet. The water separator includes at least a second separation stage with a second flow-conducting region, wherein the second separation stage is arranged downstream of the first separation stage. In this context, the second flow-conducting region includes at least one separation element which is exposed to the oncoming fluid flow.

### CROSS REFERENCE TO RELATED APPLICATIONS

This application is a continuation application of international application No. PCT/EP 2024/064615 having an international filing date of May 28, 2024, and designating the United States, the international application claiming a priority date of Jun. 13, 2023, based on German patent application No. 102023115366.8, the entire contents of the aforesaid applications being incorporated herein by reference.

### TECHNICAL FIELD

The invention concerns a water separator for separating water from a fluid flow, for example from a gas flow of a fuel cell system.

### BACKGROUND

EP 1167743 B1 discloses a water separator which is configured as a swirl separator. The water separator includes an inner pipe and an outer pipe which are arranged sequentially in axial direction, wherein the inner pipe projects with an axial section into the outer pipe and the outer pipe includes a water outlet which is arranged tangentially in the swirl direction.

### SUMMARY

It is an object of the invention to provide an improved water separator for separating water from a fluid flow, for example a gas flow of a fuel cell system.

The aforementioned object is solved according to an aspect of the invention by a water separator for separating water from a fluid flow, for example from a gas flow of a fuel cell system, including at least a first separation stage with a first flow-conducting region which is connected to a fluid conduit, wherein the first flow-conducting region includes at least one inner pipe and at least one outer pipe which are arranged in an axial direction in relation to each other, wherein the inner pipe adjoins the outer pipe and is arranged downstream of the outer pipe in flow direction, wherein in the fluid conduit a coarse water separator is arranged, wherein a separation region is arranged on a radially outer side of the inner pipe and of the outer pipe and is connected to a water outlet, including at least a second separation stage with a second flow-conducting region, wherein the second separation stage is arranged downstream of the first separation stage, wherein the inner pipe of the first flow-conducting region is coupled in fluid communication to an inlet opening of the second flow-conducting region, wherein the second flow-conducting region includes at least one separation element which is exposed to the oncoming fluid flow.

Beneficial configurations and advantages of the invention result from the description and the accompanying drawings.

According to an aspect of the invention, a water separator for separating water from a fluid flow, for example from a gas flow of a fuel cell system, is proposed, including at least a first separation stage with a first flow-conducting region which is connected to a fluid conduit. The first flow conducting region includes at least one inner pipe and at least one outer pipe which are arranged in an axial direction in relation to each other. The inner pipe adjoins the outer pipe and is arranged downstream of the outer pipe in flow direction. A coarse water separator is arranged in the fluid conduit. A separation region is arranged on a radially outer side of the inner pipe and of the outer pipe and is connected to a water outlet. Furthermore, the water separator includes at least a second separation stage with a second flow-conducting region, wherein the second separation stage is arranged downstream of the first separation stage. The inner pipe of the first flow conducting region is coupled in fluid communication to an inlet opening of the second flow-conducting region. In this context, the second flow-conducting region includes at least one separation element which is exposed to the oncoming fluid flow.

The gas flow of the fuel cell system may be, for example, air, hydrogen, or nitrogen.

The proposed water separator may be used, for example, at the cathode side and/or at the anode side of a fuel cell system, at the anode side, for example, in the recirculation circuit upstream of a feed pump.

Water from the reaction of hydrogen with oxygen is present as product water in a fuel cell system and is removed by means of water separators from the anode circuit. The separated water is usually discharged to the environment of the fuel cell system but, as needed, may also be reused for other components which require liquid water such as, for example, humidifiers for the process gases. Depending on the type and volume flow of the fuel cell, very high separation efficiencies of the water separator may be required which may be achieved only with a multi-stage process.

The proposed multi-stage water separator includes a high water separation efficiency. Thus, a first separation stage serves for separation of large water quantities from the fluid flow at the air flow inlet. Here, proportions of up to 90% of the water may be separated, for example. In a second separation stage, an impactor with downstream separation components may be arranged. The latter are employed in accordance with a modular system, either all of them or some of them, in order to separate the remaining liquid water from the fluid flow. In this way, separation components for low flow rates may be combined with separation components for high flow rates, which may be arranged in a compact configuration in the housing of the second separation stage.

The water separator may be adapted to different requirements. Long service lives of the fuel cell system may thus be achieved.

The first separation stage of the water separator may be configured as an axial cyclone. Here, by means of centrifugal forces, a wall film is generated from the liquid water of the air which drains at the inner wall of the first separation stage to the drainage.

The water droplets remaining in the air flow are guided through the inner pipe of the first separation stage configured as a connection conduit into the second separation stage in which the flow is forced to change direction multiple times. The second separation stage serves as a fine water separator for the residual water quantity of the fluid flow. In the housing of the water separator, at least one element may be provided against which the fluid flow impacts and thereby is deflected. The water droplets cannot follow the change of flow due to mass force effect and may therefore be separated. Depending on the embodiment of the housing, multiple flow deflections may take place in the second separation stage, by means of appropriately provided numerous separation elements such as, for example, a separation nonwoven, a separation impactor, a lamellar separator or the like.

In the proposed water separator a flow imparted with a swirl may be generated by means of an axial cyclone in the inlet region of the water separator, followed by subsequent separation of water in multiple separation stages by centrifugal force, inertia and/or gravity effects. The water separator thus differs beneficially from the prior art by an improved overall separation performance while having comparable pressure loss.

The water separator may be operated in horizontal installation or vertical installation, for example, in a fuel cell system.

The water separator may include a plurality of, for example, exchangeable individual parts in case of the modular system, or may be produced as a unitary component, for example, of plastic material by conventional injection molding method.

The first separation stage may be provided, for example, with a swirl generator as a coarse water separator which may be arranged either as one piece together with the fluid conduit or exchangeably arranged.

The first and the second separation stage of the water separator as well as individual elements of the second separation stage may be produced beneficially as separate components which, in case of a multi-stage water separator, may be joined modularly to an entire system in accordance with a modular system. In this context, the components and housing of the individual separation stages may be welded or glued together, for example.

According to an embodiment of the water separator, the separation element may include a surface structured opposite to the fluid flow direction and/or a nonwoven, wherein the structured surface includes a plurality of elevations, for example a plurality of parallel arranged truncated pyramids. Other forms of elevations are also possible, for example, cylinders, cuboids, spheres, cones. The fluid flow may be forced by the separation element to a change of the flow direction. Due to the sharp flow deflection of the fluid flow at the separation element and the tendency of the water droplets to move forward in a straight line, they remain in contact with the separation element for a longer period of time. The water droplets in the fluid flow remain in this context in the depth of the structured surface or in the nonwoven, become larger, and may then drain in the gravity direction downwardly into a water collection chamber.

According to an embodiment of the water separator, the separation element may be configured as an impactor plate without interior or with an interior which is downwardly open in the gravity direction. In this context, the separation element may be arranged opposite an inlet opening of the second flow-conducting region. Due to the arrangement of the separation element opposite to the inflow direction, the separation element is directly exposed to the oncoming flow and may thus force the fluid flow to a deflection of the flow direction. The impactor plate may be planar, curved, stepped or may be formed in a non-planar shape in other ways. At the separation element, which may include a closed surface or openings, separated water may drain through the interior and/or at the front side into the water collection chamber.

According to an embodiment of the water separator, a front side of the impactor plate exposed to the oncoming fluid flow may be configured as a structured surface. Water droplets may deposit or separate at the elements of the structured surface and drain downwardly in the gravity direction into a water collection chamber.

According to an embodiment of the water separator, at least one passage opening may be arranged in the front side of the impactor plate for passage of the fluid flow into the interior of the impactor plate. In this context, the at least one passage opening may have an arbitrary shape and size. For example, holes of a plurality of passage openings may have an arbitrary shape and size. Holes of a plurality of passage openings may be configured in the form of a perforation of the impactor plate. In this way, at least one part of the fluid flow may pass through the front side into the interior of the impactor plate. Liquid water of the fluid flow may thus deposit at the wall of the calmed flow interior and be separated from the fluid flow in this way.

According to an embodiment of the water separator, drainage channels for outflow of the separated water in the gravity direction may be provided at the front side of the impactor plate. In this way, water separated at the separation element may flow more easily downwardly and thereafter may be discharged in a targeted fashion into the water collection chamber.

According to an embodiment of the water separator, the nonwoven may be arranged in the interior and/or at the front side of the impactor plate. The nonwoven may thus contribute to separation of water at different locations of the separation element and may at least partially absorb the separated water.

According to an embodiment of the water separator, a first calmed flow region, for example a calmed flow region of a drainage chamber, may be formed at a side of the separation element which is facing away from the fluid flow. The calmed flow region may contribute to the additional separation of water from the fluid flow as well as guide separated wall films to the drainage point.

According to an embodiment of the water separator, the inlet opening may open into an impactor nozzle which is arranged in the interior of the second flow-conducting region and configured to guide the fluid flow against the separation element. In this manner, the separation element may be exposed to oncoming flow in a targeted fashion and the separation efficiency may be beneficially increased in this way.

According to an embodiment of the water separator, a lamellar separator may be arranged in the second separation stage. In this context, the lamellar separator may be arranged transversely to the flow direction of the fluid flow in the second flow-conducting region of the second separation stage. For example, in this context the lamellar separator may have a cross section which corresponds to a cross section of the second flow-conducting region. The lamellar separator may be arranged such that the entire fluid flow between inlet opening and outlet opening of the second separation stage of the water separator is passed through the lamellar separator. In this way, the surface area for separation of water may be enlarged and the efficiency of the water separation may be improved in this way.

According to a configuration of the water separator, an outlet pipe of the second separation stage may be arranged in a region of the second flow conducting region which is opposite to the gravity direction. For example, in this context the outlet pipe may be arranged in the second flow-conducting region diagonally opposite the inlet opening. In this way, the fluid flow may be beneficially forced to perform a deflection of the flow direction and thus to an increased water separation within the housing.

According to an embodiment of the water separator, the outlet pipe may include at its inlet opening a collar which is crimped away from the inlet opening. Behind the collar, the fluid flow may encounter a type of calmed flow zone which may contribute to an improved water separation.

According to an embodiment of the water separator, between the collar and a side wall of the second flow-conducting region at the outflow side a nonwoven which at least in sections surrounds the outlet pipe may be arranged. The nonwoven may contribute additionally to an improved water separation and absorption of separated liquid from the fluid flow.

According to an embodiment of the water separator, the nonwoven may be configured at least in sections as a part of a truncated cone wherein a tip of the cone is oriented in the direction toward the inlet opening of the outlet pipe. The shape together with the calmed flow zone may contribute additionally to an improved water separation and absorption of separated liquid from the fluid flow.

According to an embodiment of the water separator, a baffle plate may be arranged opposite the inlet opening of the outlet pipe transverse to the flow direction and spaced apart to a top side of the second flow-conducting region. The baffle plate may represent an additional possibility of deflection of the flow direction in the second separation stage, which may contribute to an improved water separation from the fluid flow.

According to a configuration of the water separator, an inner wall of the second flow-conducting region may be arranged spaced apart in relation to a side wall at the inflow side. The additional inner wall produces a region which is separated from the fluid flow and which is shielded from the air flow in the second flow-conducting region and may therefore guide separated wall films to the drainage point.

According to a configuration of the water separator, a second calmed flow region may be formed between the inner wall and the side wall at the inflow side. By means of the second calmed flow region, it may be ensured that the already separated water droplets will not be entrained again by the fluid flow and, in this way, a further possibility for an improved water separation is provided.

According to an embodiment of the water separator, a water collection chamber may be arranged in a part of the second flow-conducting region positioned at the bottom in the gravity direction. In this context, the water collection chamber may include, for example, a water outlet, for example at its lowest point. Separated water may thus collect and be discharged beneficially without the already separated liquid water proportions being swirled up again and entrained by the fluid flow.

According to an embodiment of the water separator, in the water collection chamber a water siphoning device may be provided which is connected in fluid communication to the calmed flow region of the drainage chamber of the separation element. Optionally, not only may the water thus drain freely but, for example depending on water quantity and position of the water collection chamber as well as installation position of the water separator, may be actively siphoned away additionally. The water siphoning device may be arranged in combination with an impactor plate which includes an interior.

According to an embodiment of the water separator, a receiving pipe with an outlet pipe arranged in the interior of the receiving pipe may be arranged at the inlet opening of the second flow-conducting region. In this context, the separation element may be arranged at an inner side of the receiving pipe and may surround the outlet pipe at least partially. The outlet pipe may be closed at its downstream end at least partially and include a plurality of fluid passage openings positioned opposite the separation element. The fluid flow may thus be forced already by the outlet pipe to a deflection of the flow direction and may be guided to the separation element which is arranged about the outlet pipe, for example, in an annular shape. In this way, an additional separation of liquid water from the fluid flow may be effectively generated immediately after exiting from the outlet pipe.

According to an embodiment of the water separation device, the receiving pipe may be arranged in the second flow-conducting region. In a simplified embodiment, the second separation stage of the water separator may thus include the receiving pipe and the separation element arranged about the outlet pipe. In this way, a particularly compact configuration of the water separator is possible.

### BRIEF DESCRIPTION OF DRAWINGS

Further advantages result from the following description and the accompanying drawings. In the drawings, embodiments of the invention are illustrated. The drawings in conjunction with the description contain numerous features in combination. A person of skill in the art will expediently consider the features also individually and combine them to expedient further combinations. It is illustrated in an exemplary fashion in schematic illustration in:

FIG. 1 a section illustration of a water separator for separating water from a fluid flow, for example from an air flow of a fuel cell system, according to an embodiment of the invention;

FIG. 2 a section illustration of a water separator according to a further embodiment of the invention;

FIG. 3 a section illustration of a water separator according to a further embodiment of the invention;

FIG. 4 a section illustration of a water separator according to a further embodiment of the invention;

FIG. 5 a section illustration of a water separator according to a further embodiment of the invention;

FIG. 6 a section illustration of a water separator according to a further embodiment of the invention;

FIG. 7 a section illustration of a water separator according to a further embodiment of the invention;

FIG. 8 a section illustration of a water separator with a simplified second separation stage according to a further embodiment of the invention;

FIG. 9 a section illustration of a water separator with a simplified second separation stage according to a further embodiment of the invention;

FIG. 10 a section illustration of a water separator according to a further embodiment of the invention;

FIG. 11 a section illustration of a second separation stage according to a further embodiment of the invention, which is arranged downstream of a first separation stage, provided with an alternative arrangement of impactor plate and separation collar;

FIG. 12 a section illustration of the second separation stage along the section line B-B according to FIG. 11;

FIG. 13 a section illustration of the second separation stage along the section line C-C according to FIG. 11;

FIG. 14 a plan view of a separation element of a water separator according to an embodiment of the invention;

FIG. 15 a section illustration of the separation element along the section line A-A according to FIG. 14;

FIG. 16 an enlarged illustration of the detail C of the section illustration according to FIG. 15;

FIG. 17 an enlarged illustration of the detail B of the plan view of FIG. 14;

FIG. 18 a plan view of a separation element according to a further embodiment of the invention;

FIG. 19 a section illustration of the separation element along the section line A-A according to FIG. 18;

FIG. 20 a plan view of a separation element according to a further embodiment of the invention;

FIG. 21 a section illustration of the separation element along the section line A-A according to FIG. 20;

FIG. 22 a plan view of a separation element according to a further embodiment of the invention;

FIG. 23 a section illustration of the separation element along the section line A-A according to FIG. 22;

FIG. 24 an enlarged illustration of a detail of the section illustration according to FIG. 23;

FIG. 25 an enlarged illustration of a detail of the plan view of FIG. 22;

FIG. 26 a plan view of a separation element according to a further embodiment of the invention;

FIG. 27 a section illustration of the separation element along the section line A-A according to FIG. 26;

FIG. 28 an enlarged illustration of the detail B of the section illustration according to FIG. 27; and

FIG. 29 an enlarged illustration of the detail C of the plan view of FIG. 26.

### DETAILED DESCRIPTION

In the drawing figures, same or same-type components are identified with same reference characters. The drawing figures show only examples and are not to be understood as limiting.

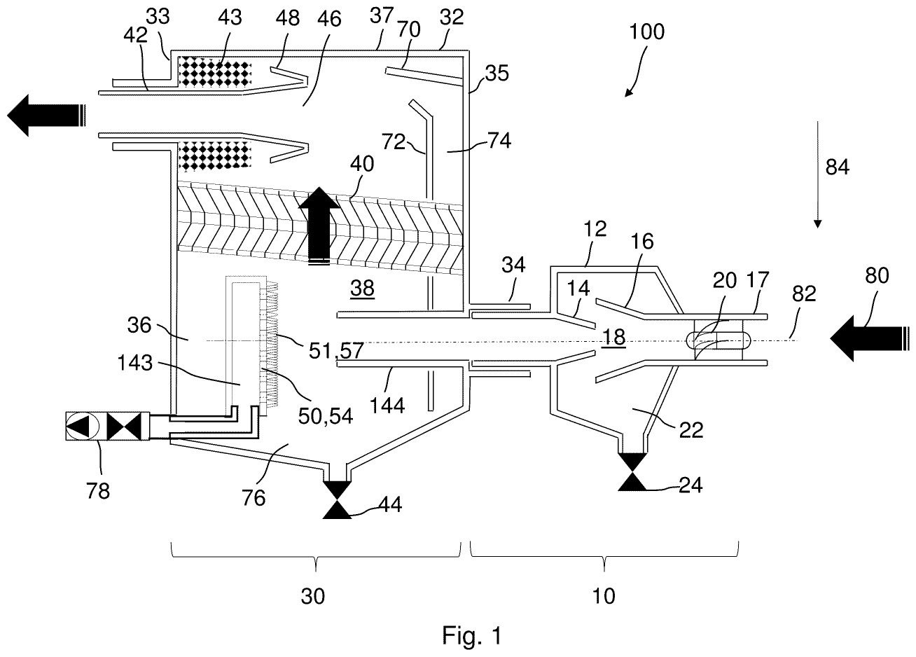

FIG. 1 shows a schematic section illustration of a water separator 100 for separation of water from a fluid flow, for example from a gas flow of a fuel cell system, for example from air, hydrogen, or nitrogen, according to an embodiment of the invention.

The water separator 100 comprises a first separation stage 10 with a first flow-conducting region 18 which is connected to a fluid conduit 17.

The first separation stage 10 serves as a main separator for larger water quantities at the fluid flow inlet.

The first flow-conducting region 18 comprises an inner pipe 14 and an outer pipe 16 which are arranged relative to each other in an axial direction 82. The inner pipe 14 adjoins the outer pipe 16 and is arranged in flow direction 80 downstream of the outer pipe 16. The flow direction 80 is indicated with arrows. The first separation stage 10 is arranged here in a housing 12.

A coarse water separator 20 is arranged in the fluid conduit 17. The coarse water separator 20 may be, for example, a swirl generator in the form of an axial cyclone. In the housing 12, a separation region 22 is arranged on a radial outer side of the inner pipe 14 and of the outer pipe 16. The separation region 22 is connected to a water outlet 24 which is arranged in the gravity direction 84 at the bottom of the housing 12.

In the first separation stage 10, the air which is entering in this context via the fluid conduit 17 is guided to the coarse water separator 20. In doing so, the air is caused to rotate and exits through the funnel-shaped expanded outer pipe 16 into the separation region 22 of the housing 12. By means of centrifugal forces, the water droplets contained in the air are moved outwardly in radial direction in relation to the flow and generate a wall film at the inner wall of the water separation region 22 of the first separation stage 10 which moves in the direction toward the drainage region. The separated water is able to drain toward the water outlet 24.

The water separator 100 comprises furthermore a second separation stage 30 with a second flow-conducting region 38, wherein the second separation stage 30 is arranged downstream of the first separation stage 10 and combines different separation elements with each other according to a modular system. The second separation stage 30 is arranged in a housing 32.

The second separation stage 30 serves as a fine water separator for the residual water quantity in the fluid flow.

The inner pipe 14 of the first separation stage 10 is coupled in fluid communication to an inlet opening 34 of the second flow-conducting region 38. In a further embodiment, the inner pipe 14 may also project into the housing 32 for this purpose.

The second flow-conducting region 38 comprises a separation element 50 which is embodied as an impactor plate 54 which is exposed to the oncoming fluid flow entering the housing 32 of the second separation stage 30 through the inner pipe 14 and guided therein farther through the impactor nozzle 144. At the front side 56 which is oriented against the fluid flow, the impactor plate 54 comprises a structured surface 51 with pyramid-shaped elevations 57. Behind the separation element 50, at a side of the separation element 50 which is facing away from the fluid flow, a first calmed flow region 36 is formed.

A water collection chamber 76 for separated water is arranged in a part of the housing 32 which is positioned at the bottom in the gravity direction 84. The water collection chamber 76 comprises at its lowest point a water outlet 44 for draining the separated water.

The calmed flow region 36 is connected in fluid communication to the water collection chamber 76. At the side of the separation element 50 facing away from the fluid flow, a further calmed flow region of the drainage chamber 143 is formed which is connected in fluid communication to a water siphoning device 78.

The air which has impacted on the separation element 50 and has experienced thereat a deflection of the flow direction then impacts on lamellar separator 40. The lamellar separator 40 is arranged transversely to the flow direction 80 of the fluid flow in the second flow-conducting region 38. The lamellar separator 40 comprises in this context a cross section which corresponds to a cross section of the second flow-conducting region 38 so that the fluid flow in any case must pass completely through the lamellar separator 40.

An outlet pipe 42 of the second separation stage 30 is arranged in a region of the second flow-conducting region 38 opposite to the gravity direction 84. In this context, the outlet pipe 42 is for example arranged diagonally opposite the inlet opening 34 of the second flow-conducting region 38 in order to achieve a beneficial flow conduction through the second flow-conducting region 38.

The outlet pipe 42 comprises at its inlet opening 46 a collar 48 which is crimped away from the inlet opening 46. Between the collar 48 and a side wall 33 of the housing 32 at the outflow side, a nonwoven 43 is arranged which surrounds the outlet pipe 42 at least in sections, for example in an annular shape. The nonwoven 43 abuts the side wall 33 at the outflow side and is spaced apart from the top side 37 of the second flow-conducting region 38. The nonwoven 43 may have different cross sections and contour courses. In case of a corresponding material thickness, the top side 37 is at least partially contacted.

Opposite the inlet opening 46 of the outlet pipe 42, a baffle plate 70 is arranged transverse to the flow direction 80 and spaced apart from a top side 37 of the second flow-conducting region 38.

Furthermore, an inner wall 72 is spaced apart from a side wall 35 at the inflow side. Between the inner wall 72 and the side wall 35 at the inflow side, a further calmed flow region 74 is formed. The further calmed flow region 74 is also connected in fluid communication to the water collection chamber 76.

The water droplets which remain in the air flow after the preseparation of water in the first separation stage 10 are thus guided through the inner pipe 14 of the first separation stage 10, which is formed as a connecting conduit, into the second separation stage 30 in which the flow is forced to perform several directional changes.

At the location of the flow deflection, at least one element may be provided against which the fluid flow impacts and which absorbs the water droplets which cannot follow the change in flow due to the inertia effect. Depending on the embodiment of the housing 32, in the second separation stage 30 a plurality of deflections may take place with appropriately provided numerous separation elements, for example, a separation element 50 configured as impactor plate 54, lamellar separator 40, separation collar 48, separation nonwoven 43 or the like.

In the embodiment illustrated in FIG. 1, the fluid flow from the impactor nozzle 144 impacts directly on the separation element 50. At the separation element 50, the fluid flow is first slowed and deflected so that a further portion of the water entrained in the fluid flow may deposit or may be separated. The space behind the separation element 50 forms a drainage chamber 143 with a calmed flow region 36 which is connected in fluid communication to the water collection chamber 76. As an alternative, the drainage chamber 143 with the calmed flow region 36 may be connected in fluid communication to the water siphoning device 78.

The deflected fluid flow passes then through the lamellar separator 40. The latter serves to separate a further portion of liquid water in a region of low flow rate.

Subsequently, the fluid flow fills the upper region of the second flow-conducting region 38 in which the outlet pipe 42 with its crimped collar 48 and the nonwoven 43 arranged around it provides a further reduction of the liquid water contents. Water droplets may be separated at the baffle plate 70 which is arranged opposite the inlet opening 46 of the outlet pipe 42. The inner wall 72 with the calmed flow region 74 arranged behind it provides an additional calmed flow region 74, whereby the drainage from this part of the second flow-conducting region 38 is facilitated. The calmed flow region 74 may be beneficially connected in fluid communication to the water collection chamber 76 for this purpose.

In the embodiment illustrated in FIG. 1, the separation element 50 comprises a structured surface 51. The structured surface 51, which is illustrated only schematically, may comprise, for example, a plurality of elevations 57 oriented opposite to the fluid flow direction, in the illustrated embodiment parallel-arranged truncated pyramids. Due to the impact of the fluid flow on the truncated pyramids 57, the fluid flow may be slowed significantly and deflected so that liquid water may deposit on the truncated pyramids 57 and drain downwardly.

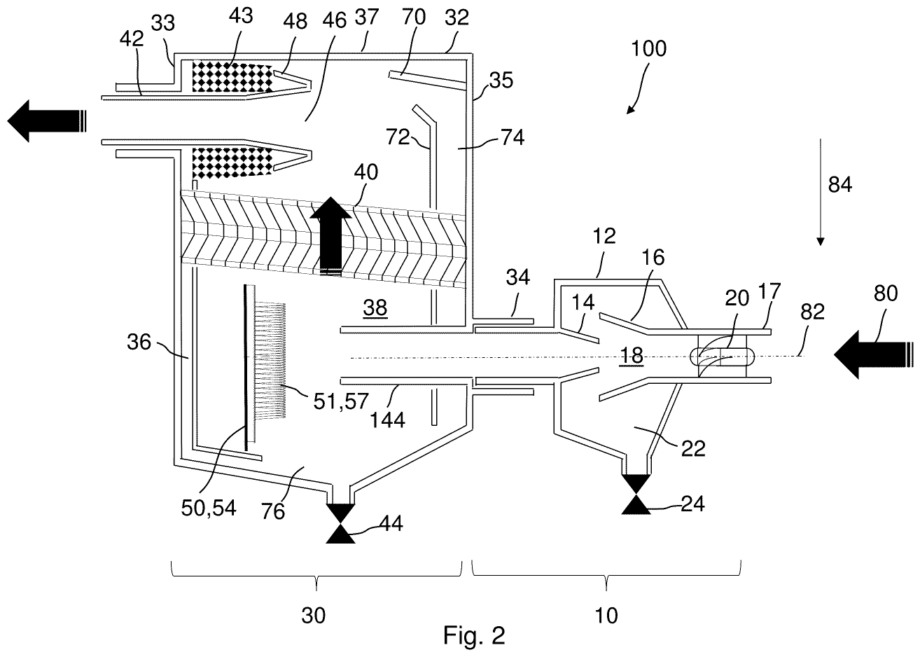

In FIG. 2, a section illustration of a water separator 100 according to a further embodiment of the invention is illustrated. In this embodiment, the nonwoven 43 arranged about the outlet pipe 42 is moved away from the side wall 33 of the housing 32 and adjoins directly the crimped collar 48 of the outlet pipe 42. The nonwoven 43 may have different dimensions and shapes. The free space between side wall 33 and collar 48 may be furnished with nonwoven 43 of different size and shape. In this way, a calmed flow zone with defined properties may be additionally produced.

In this embodiment, the separation element 50 is also formed as impactor plate 54 with pyramid-shaped elevations 57 of the structured surface 51.

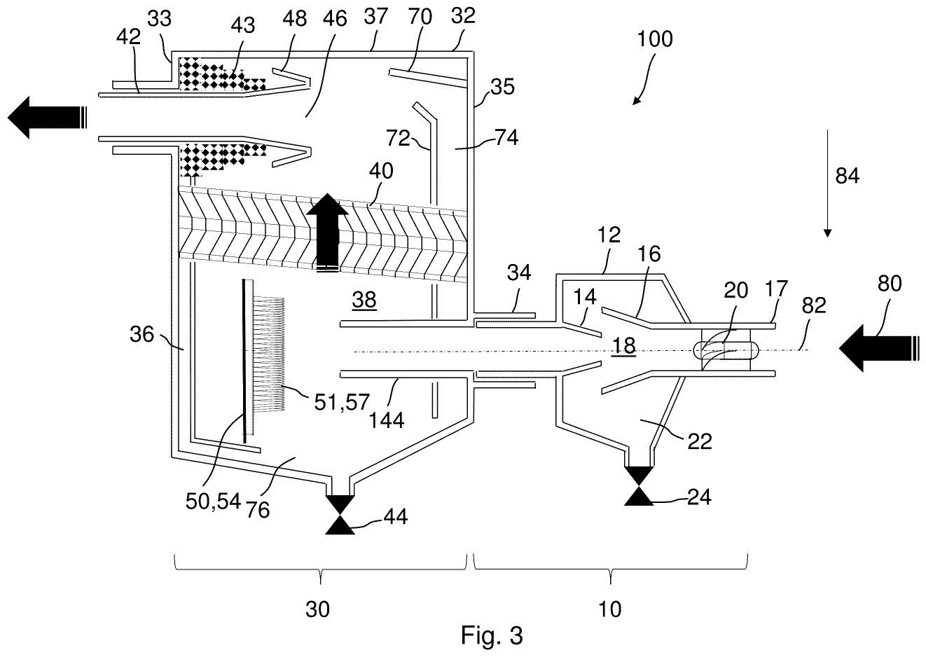

FIG. 3 shows a section illustration of a water separator 100 according to further embodiment of the invention in which the nonwoven 43 is formed in a cone shape, wherein a tip of the cone is oriented in the direction toward the inlet opening 46. With this embodiment of the nonwoven 43, an advantageous separation of liquid water from the fluid flow may be achieved also.

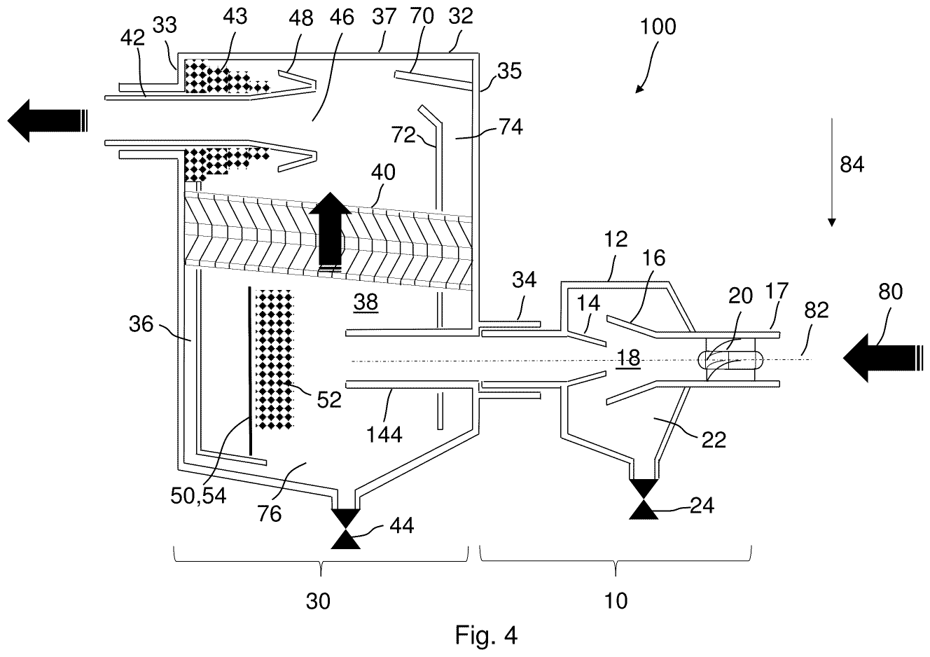

In FIG. 4, a section illustration of a water separator 100 according to a further embodiment of the invention is illustrated in which the nonwoven 43 around the outlet pipe 42 has the same configuration as in the embodiment illustrated in FIG. 3. However, the separation element 50 configured as an impactor plate 54 comprises no structured surface 51 but a nonwoven 52. Water drops which impact directly on the nonwoven 52 penetrate into the depth of the nonwoven 52 and are thereby separated from the deflected fluid flow. In the nonwoven 52, a large quantity of liquid water may thus be absorbed without being entrained again by the fluid flow. The absorbed water may then flow beneficially out of the nonwoven 52 into the water collection chamber 76.

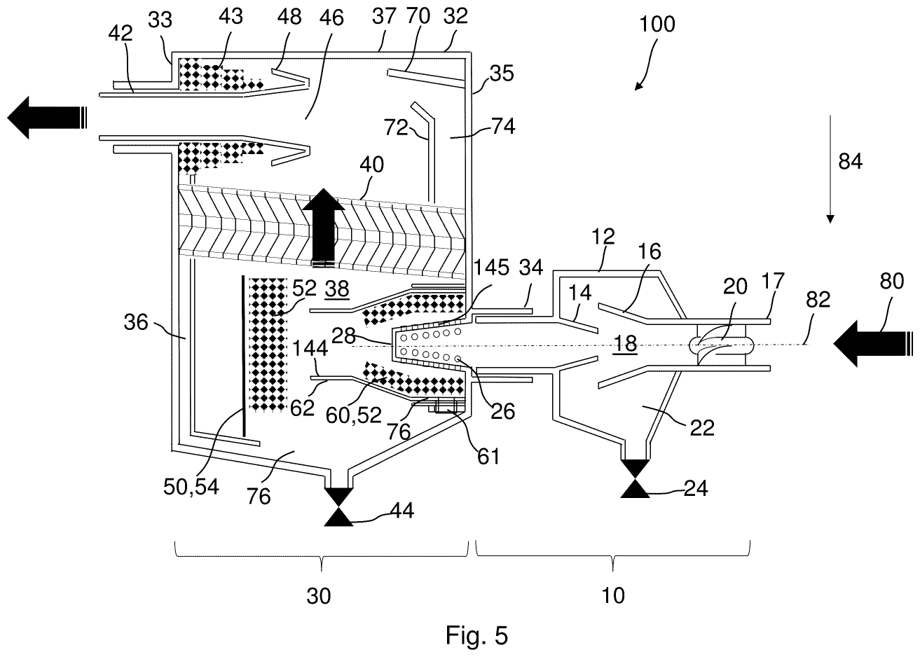

FIG. 5 shows a section illustration of a water separator 100 according to a further embodiment of the invention.

The water separator 100 is embodied substantially as in the embodiment illustrated in FIG. 4. However, here a receiving pipe 62 is arranged at the inlet opening 34 of the second flow-conducting region 38, with an outlet pipe 145 received in the interior of the receiving pipe 62. In this context, a further separation element 60 is arranged at an inner side of the receiving pipe 62. The separation element 60 surrounds the outlet pipe 145 at least in sections. The outlet pipe 145 is closed at least partially at its end 28 at the downstream side. Further, the outlet pipe 145 comprises a plurality of fluid passage openings 26 positioned opposite the separation element 60.

The fluid flow flowing through the inner pipe 14 may flow into the outlet pipe 145, may exit again through the fluid passage openings 26 from the outlet pipe 145, and is thus deflected in respect to the flow direction 80. In this context, the fluid flow, when it exits from the outlet pipe 145, impacts directly on the separation element 60 which is also embodied with a nonwoven 52 in this embodiment. A further water separation may thus take place at the additional separation element 60. The receiving pipe 62 comprises for this purpose an additional drainage 61 through which the separated water may reach the water collection chamber 76 of the housing 32.

The embodiment illustrated in FIG. 5 thus represents a water separator 100 which comprises within the second separation stage 30 a further optional separation stage in the form of the separation element 60 inside the receiving pipe 62 in accordance with the modular system. In this way, a further improved separation performance may be achieved.

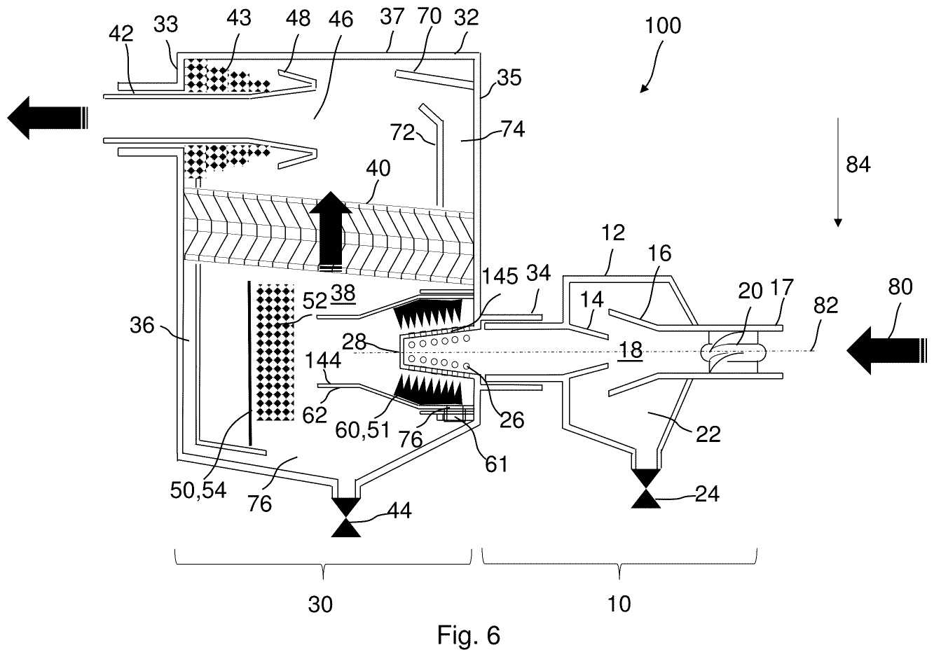

The section illustration of a water separator 100 illustrated in FIG. 6 shows a further embodiment, similar to the embodiment illustrated in FIG. 5, with a separation element 60 arranged within the receiving pipe 62 which is however provided with a structured surface 51 in contrast to the embodiment illustrated in FIG. 5. The total separation performance of the water separator 100 may also be improved thereby.

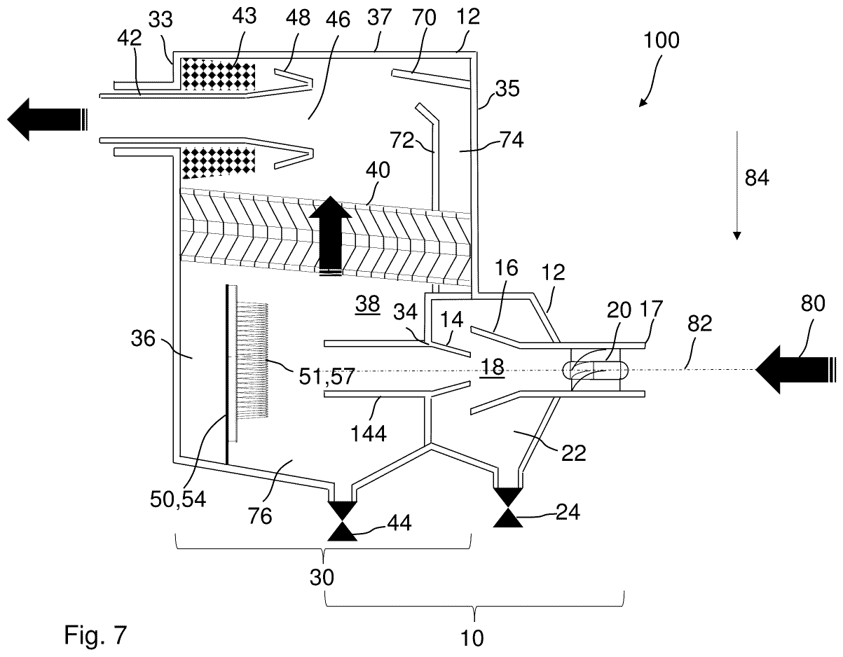

FIG. 7 shows a section illustration of a water separator 100 according to a further embodiment of the invention.

The important difference to the embodiments illustrated in FIGS. 1 through 6 resides in that the two separation stages 10, 30 are not arranged in separate housings 12, 32 which may be beneficially joined to the water separator 100 but in that the two separation stages 10, 30 are arranged in a single housing 12. In this context, the inner pipe 14 of the first separation stage 10 is formed as one piece together with the impactor nozzle 144 of the second separation stage 30.

In the embodiment illustrated in FIG. 7, the separation element 50 is formed with pyramid-shaped elevations 57 of the structured surface 51. The nonwoven 43 is embodied in an arrangement as illustrated in the embodiment of FIG. 1. As an alternative, the other embodiments for the separation element 50 and the nonwoven 43 illustrated in FIGS. 1 through 6 are possible also.

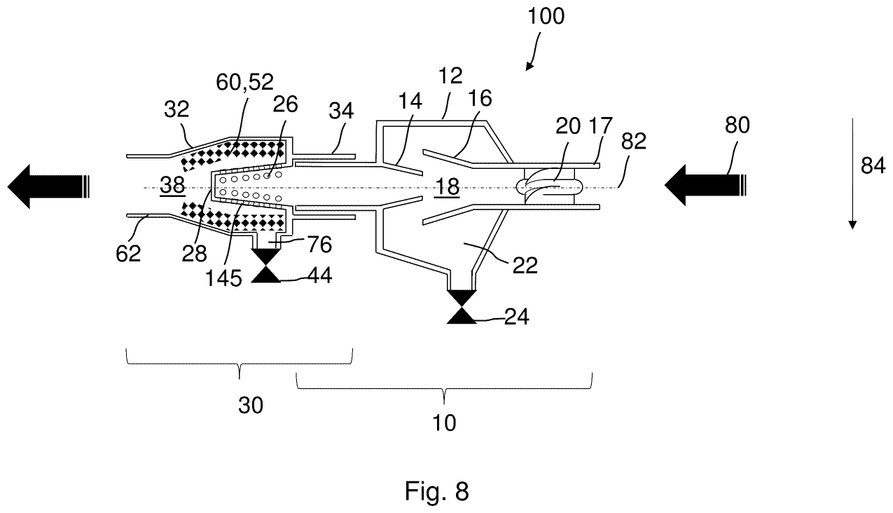

FIG. 8 shows a section illustration of a water separator 100 with a simplified second separation stage 30 according to further embodiment of the invention.

This embodiment is derived from the embodiment illustrated in FIG. 5. The housing 32 of the second separation stage 30 is embodied as a receiving pipe 62 at the inlet opening 34 of the second flow-conducting region 38, with an outlet pipe 145 arranged in the interior of the receiving pipe 62. In this context, a separation element 60 is arranged at an inner side of the receiving pipe 62 and surrounds the outlet pipe 145 at least in sections. The outlet pipe 145 is at least partially closed at its end 28 at the downstream side and comprises a plurality of fluid passage openings 26 positioned opposite the separation element 60.

The inner pipe 14 of the first separation stage 10 is directly coupled in fluid communication to the inlet opening 34 so that the fluid flow may flow through the inner pipe 14 into the outlet pipe 145.

The fluid flow flowing through the inner pipe 14 may thus enter the outlet pipe 145, may exit again through the fluid passage openings 26 from the outlet pipe 145, and is thus deflected in respect to the flow direction 80. In this context, the fluid flow when it exits from the outlet pipe 145 impacts directly on the separation element 60 which is also formed with a nonwoven 52 in this embodiment. A further water separation may take place in this way at the additional separation element 60. For this purpose, the receiving pipe 62 comprises a water outlet 44 through which the separated water may exit from the water collection chamber 76 of the housing 32.

In this manner, a water separator 100 of a particularly compact construction may be realized which nonetheless exhibits an effective water separation capability.

The thus realized water separator 100 represents a further example of a beneficial water separator 100 built in a modular construction of individual modularly mountable components.

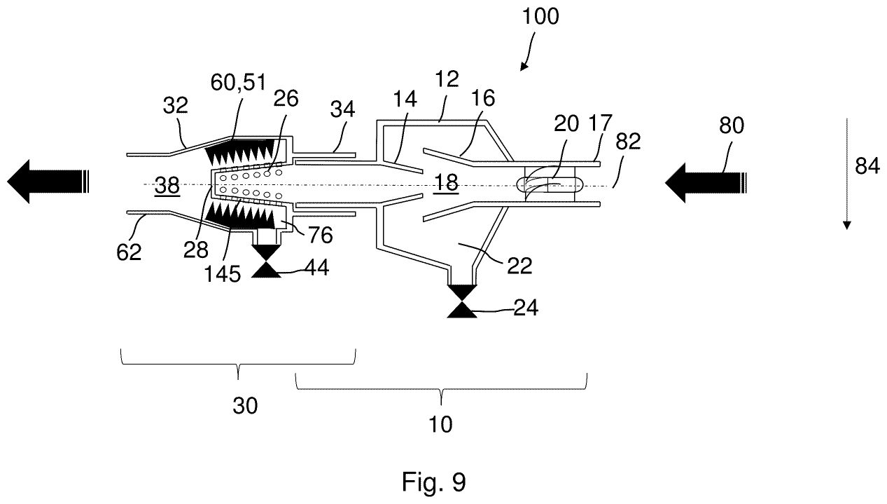

FIG. 9 shows a further embodiment of a water separator 100 designed in this way in which according to the embodiment in FIG. 6 the separation element 60 is configured as a structured surface 51. In this way, water may also be separated effectively from the fluid flow in a very compact way.

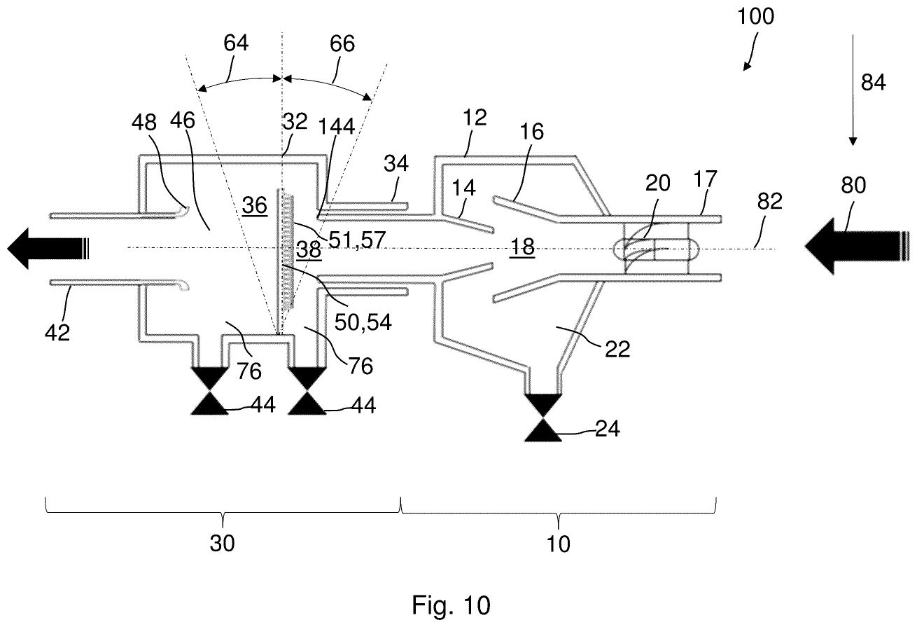

FIG. 10 shows a section illustration of a water separator 100 according to a further embodiment of the invention.

In this embodiment, the first separation stage 10 corresponds to the first separation stage 10 of the embodiments illustrated in the FIGS. 1 through 6. The second separation stage 30 is however of a different configuration.

The second separation stage 30 is arranged in a housing 32 and serves as a fine water separator for the residual water quantity in the fluid flow.

The inner pipe 14 of the first separation stage 10 is coupled in fluid communication to the inlet opening 34 of the second flow-conducting region 38.

The second flow-conducting region 38 comprises a separation element 50 which is formed as an impactor plate 54 which is exposed to the oncoming fluid flow which is entering the housing 32 of the second separation stage 30 through the inner pipe 14 and is further guided from there through the impactor nozzle 144. The impactor plate 54 comprises at the front side 56 facing the fluid flow a structured surface 51, for example with pyramid-shaped elevations 57. Behind the separation element 50, at a side of the separation element 50 which is facing away from the fluid flow, a first calmed flow region 36 is formed.

A water collection chamber 76 for the separated water is arranged in a part of the housing 32 which is at the bottom in the gravity direction 84. The water collection chamber 76 comprises at a bottom surface two water outlets 44 for draining the separated water.

The calmed flow region 36 is connected in fluid communication to the water collection chamber 76.

An outlet pipe 42 is arranged in axial direction 82 opposite the inlet opening 34 of the second flow-conducting region 38 in order to achieve a beneficial flow guiding action through the second flow-conducting region 38.

The outlet pipe 42 comprises at its inlet opening 46 a collar 48 crimped away from the inlet opening 46.

The water droplets which remain in the air flow after the preseparation of water in the first separation stage 10 are thus guided through the inner pipe 14 of the first separation stage 10 formed as a connection conduit into the second separation stage 30 in which the flow is forced to perform a change in direction.

At the location of the flow deflection, at least one element may be located on which the fluid flow impacts and which absorbs the water droplets which cannot follow the change in flow due to the inertia effect. Depending on the embodiment of the housing 32, a separation element 50 formed as an impactor plate 54 may be arranged in the second separation stage 30 for deflection, for example.

In the embodiment illustrated in FIG. 10, the fluid flow from the impactor nozzle 144 impacts directly on the separation element 50. At the separation element 50, the fluid flow is initially slowed and deflected so that a further portion of the water entrained in the fluid flow may be deposited or separated.

Subsequently, the fluid flow fills the region of the second flow-conducting region 38 in which the outlet pipe 42 with its crimped collar 48 ensures a further reduction of the liquid water contents.

The separation element 50 in the embodiment illustrated in FIG. 10 comprises a structured surface 51. The structured surface 51 which is illustrated only schematically may comprise, for example, a plurality of elevations 57 oriented opposite to the fluid flow direction, in the illustrated embodiment parallel arranged truncated pyramids. Due to the fluid flow impacting on the truncated pyramids 57, the fluid flow may be slowed significantly and deflected so that liquid water may deposit on the truncated pyramids 57 and drain downwardly.

In this context, the impactor plate 54 corresponds to the embodiment illustrated in FIG. 2.

The impactor plate 54 of the separation element 50 may be inclined in relation to the axial direction 82. The impactor plate 54 may thus be arranged, for example, perpendicularly to the axial direction 82, as illustrated in the embodiment. As an alternative, it is however also possible that the impactor plate is inclined in relation to the vertical at an angle 64 away from the axial direction 82 or at an angle 66 toward the axial direction 82 in order to beneficially change the separation effect of the separation element 50.

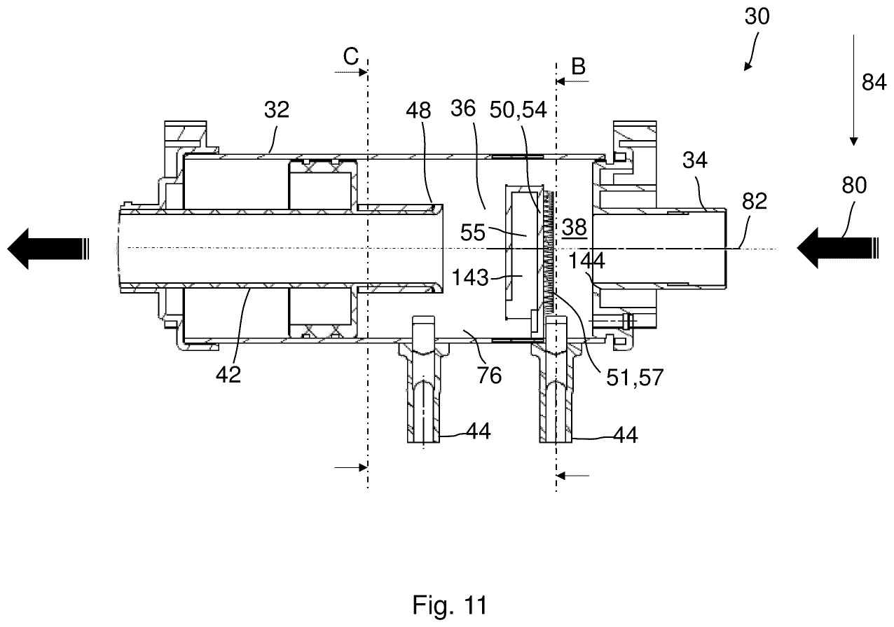

FIG. 11 shows a section illustration of a second separation stage 30 according to a further embodiment of the invention, which is arranged downstream of the first separation stage 10, provided with an alternative arrangement of impactor plate 54 and separation collar 48.

The embodiment illustrated in FIG. 11 may represent, for example, a realization of the second separation stage 30 of the water separator 100 illustrated in FIG. 10.

The second separation stage 30 with the second flow-conducting region 38 is configured in a simplified construction in a cylindrical housing 32. Impactor nozzle 144 and separation element 50 are arranged at a defined spacing.

The separation element 50 is configured as an impactor plate 54 with pyramid-shaped elevations 57 and comprises an interior 55 which is configured as a drainage chamber 143 with a calmed flow region. In this arrangement, a further calmed flow region 36 is produced behind the separation element 50.

The outlet pipe 42 comprises a separation collar 48. A beneficially arranged water outlet 44 is connected in fluid communication to the water collection chamber 76.

In the embodiment of a second separation stage 30 illustrated in FIG. 11, impactor nozzle 144, separation element 50, separation collar 48, and outlet pipe 42 are embodied in a housing 32 in a coaxial arrangement and have defined spacings relative to each other.

The separated water collected in the water collection chamber 76 may drain via the water outlets 44.

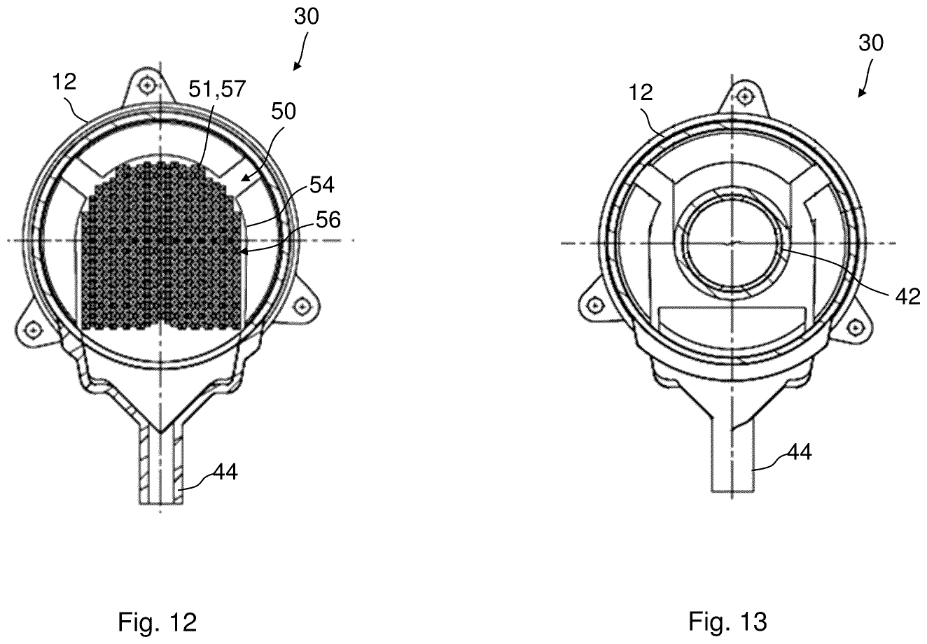

FIG. 12 shows a section illustration of the second separation stage 30 along the section line B-B according to FIG. 11. A plan view of the impactor plate 54 forming the separation element 50 may be seen. The impactor plate 54 comprises a structured surface 51 with pyramid-shaped elevations 57. The impactor plate 54 may have any arbitrary shape, for example, a round or angular contour. The inner wall of the housing 12 and the outer contour of the impactor plate 54 may be spaced at a nonuniform spacing. The water outlet 44 may be seen in section.

FIG. 13 shows a section illustration of the second separation stage 30 along the section line C-C according to FIG. 11. In this context, a section through the outlet pipe 42 may be seen. Impactor plate 54 and separation collar 48 have a different outer contour. The housing 12 may have any arbitrary shape, for example, round or angular.

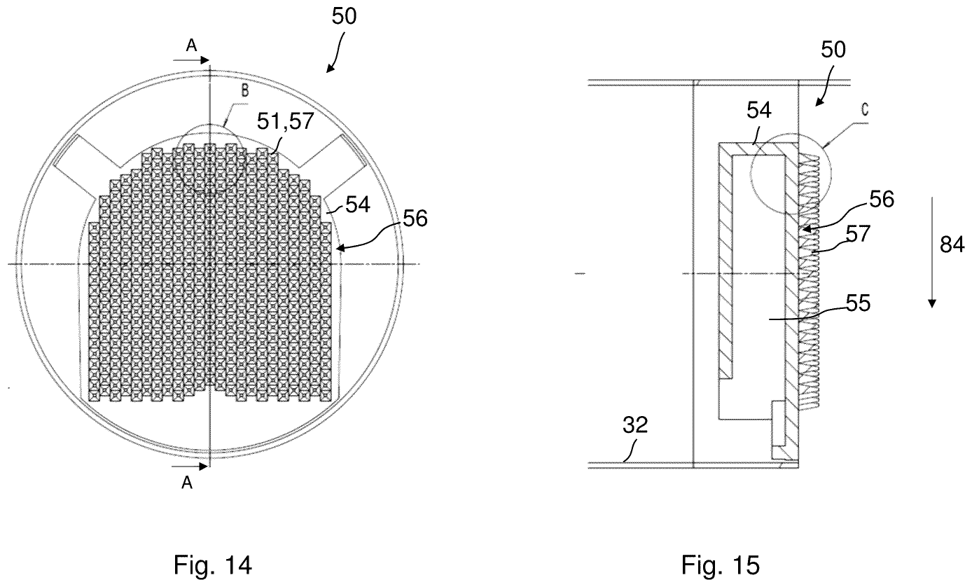

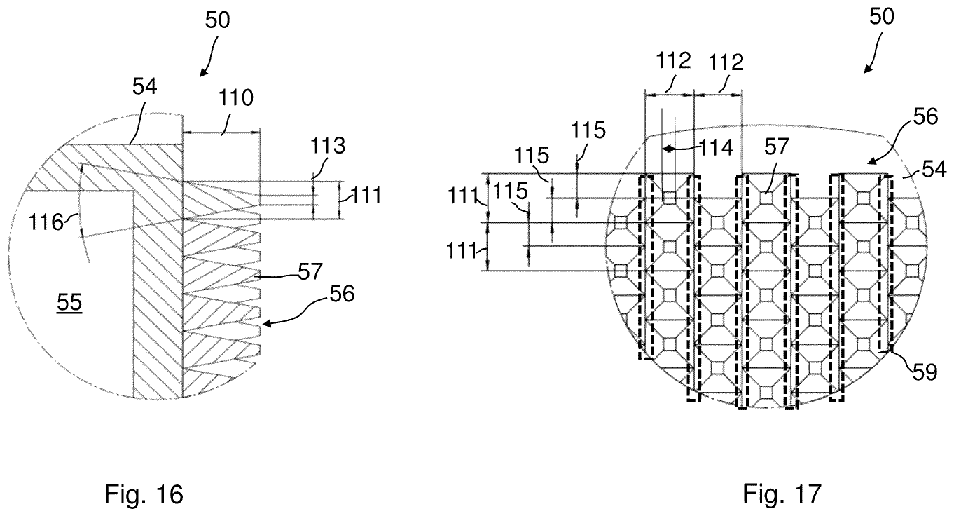

FIG. 14 shows a plan view of a separation element 50 of a water separator 100 according to an embodiment of the invention. In FIG. 15, a section illustration of the separation element 50 along the section line A-A according to FIG. 14 is illustrated while FIG. 16 shows an enlarged illustration of the detail C of the section illustration according to FIG. 15 and FIG. 17 an enlarged illustration of the detail B of the plan view of FIG. 14.

The separation element 50 formed as an impactor plate 54 comprises a structured surface 51, i.e., represents an embodiment as it is used in the water separators illustrated in FIGS. 1 to 3. The structured surface 51 comprises parallel arranged rows of truncated pyramids 57 as elevations which are oriented opposite to the fluid flow direction. The truncated pyramids 57 in immediately adjacently positioned rows are arranged offset to each other, respectively. Due to the fluid flow impacting on the truncated pyramids 57, the fluid flow may be slowed significantly and deflected so that liquid water may deposit at the truncated pyramids 57 and/or may be separated thereat.

As may be seen for example in FIG. 15, the separation element 50 is formed as an impactor plate 54 with an interior 55 which is open downwardly in the gravity direction 84. As an alternative, the separation element 50 may also have a curved shape or may be formed as a curved plate. In this context, the separation element 50 is arranged in the second separation stage 30 of the water separator 100 opposite the inflow opening 34 of the housing 32, as may be seen in FIGS. 1 to 3, and the fluid flow flows against directly against it. The separation element 50 may be fixed to a bottom of the housing 32, for example.

In the embodiment illustrated in FIGS. 14 to 17 of a separation element 50, the front side 56 of the impactor plate 54 exposed to the oncoming fluid flow is embodied as a structured surface 51.

In the detail illustrations in FIGS. 16 and 17, the truncated pyramids 57 of the structured surface 51 are illustrated enlarged. In this way, beneficial dimensions for the truncated pyramids 57 may be defined.

A height 110 of the truncated pyramids 57 may lie beneficially between about 4 mm and about 40 mm and, for example, amount to about 8 mm. An edge length 111, 112 of a base surface of the truncated pyramid 57 may lie beneficially between about 1 mm and about 20 mm and, for example, may amount to about 4 mm. The base surface, as in the illustrated embodiments, may be square so that the two edge lengths 111, 112 are identical. An edge length 113, 114 of an end surface of the truncated pyramid 57 may lie beneficially between about 0.25 mm and about 5 mm and, for example, may amount to about 1 mm. When the base surface is square, the end surface beneficially may also be square so that the two edge lengths 113, 114 are identical. An angle between the lateral surfaces of the truncated pyramid 57 amounts to about 21° for these measures, for example.

A row offset 115 between the truncated pyramids 57 of neighboring rows of truncated pyramids 57 amounts to, as may be seen in FIG. 12, half an edge length 111 of the base surface, in the illustrated embodiment thus about 2 mm.

As may also be seen in FIG. 17, drainage channels 59 in the gravity direction 84 for drainage of the separated water are formed at the front side 56 of the impactor plate 54. The drainage channels 59 are positioned respectively between the rows of the truncated pyramids 57. A width of the drainage channels 59 may lie beneficially between about 0.25 mm and about 5 mm.

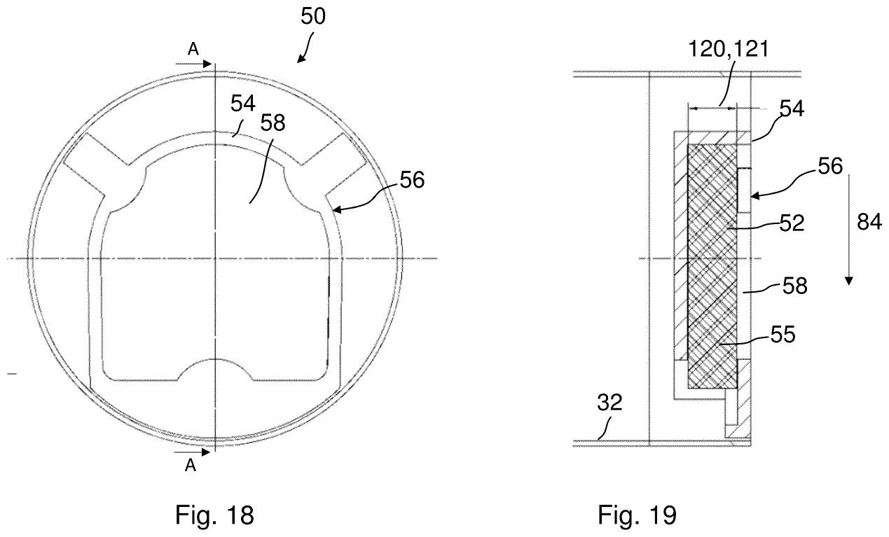

FIG. 18 shows a plan view of a separation element 50 according to a further embodiment of the invention while in FIG. 19 a section illustration of the separation element 50 along the section line A-A according to FIG. 18 is illustrated.

In this embodiment, the impactor plate 54 comprises at its front side 56 a large passage opening 58 through which the fluid flow may enter the interior 55. The interior 55 is filled with a nonwoven 52 at which water may be separated from the fluid flow. At the bottom side of the interior 55 which is open toward the housing 32 of the second separation stage 30, the separated water may drain into the water collection chamber 76. As may be seen in FIG. 19, the nonwoven may completely fill the interior 55. A depth 121 of the interior 55 as well as the thickness 120 of the nonwoven 52 may lie beneficially between about 0.1 mm and about 50 mm, for example, may amount to about 20 mm.

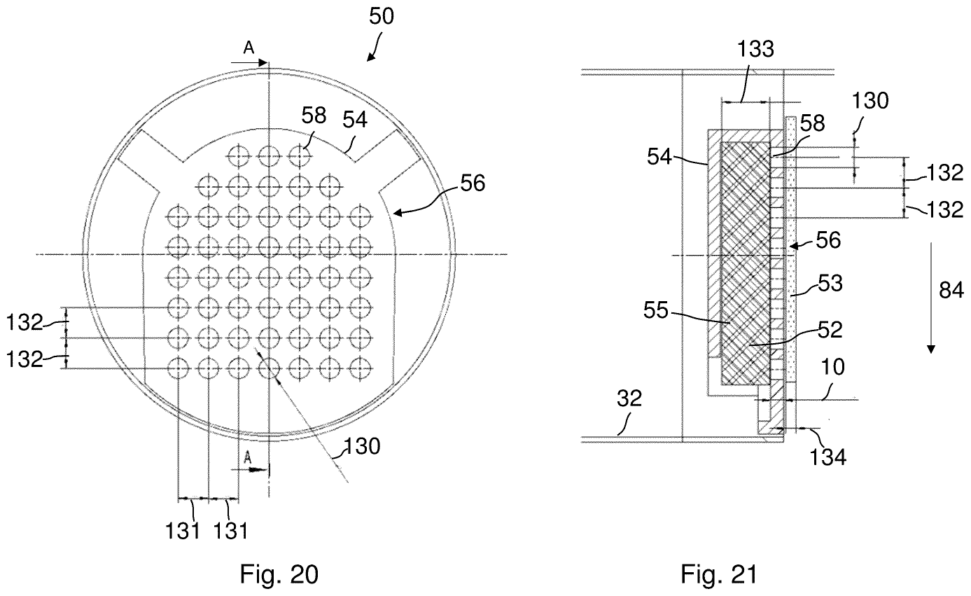

In FIG. 20, a plan view of the separation element 50 according to a further embodiment of the invention is illustrated while in FIG. 21 a section illustration of the separation element 50 along the section line A-A according to FIG. 20 is illustrated.

In this embodiment, the front side 56 of the impactor plate 54 comprises a plurality of small passage openings 58 through which the fluid flow may pass into the interior 55 of the impactor plate 54. The plurality of small passage openings 58 may be realized in the form of a perforation. Holes of the plurality of small passage openings 58 may comprise any arbitrary shape and size. As in the preceding embodiment, the interior 55 is filled with the nonwoven 52. As may be seen in FIG. 21, a further nonwoven 53 is arranged at the front side 56 of the impactor plate 54 in flow direction upstream of the passage openings 58 and may serve as a preseparation stage of water, for example.

A diameter 130 of the passage openings 58 may lie beneficially between about 1 mm and about 20 mm and, for example, may amount to about 8 mm. A horizontal spacing 131 as well as a vertical spacing 132 between the passage openings 58 may lie between about 1.5 mm and about 30 mm and, for example, may amount to about 12 mm. However, the hole pattern may also be non-symmetrical so that spacings and angles of neighboring center points of the passage openings 58 may be variable. A thickness 133 of the nonwoven 52 in the interior 55 may lie between about 0.1 mm and about 50 mm and, for example, may amount to about 20 mm. A thickness 134 of the nonwoven 53 at the front side 56 may lie between about 0.1 mm and about 50 mm and, for example, may amount to about 4 mm.

Both nonwovens 52, 53 may be present in the separation element 50. As an alternative, it is however also possible that only one nonwoven 52 is present in the interior 55 or only one nonwoven 53 at the front side 56 of the planar impactor plate 54.

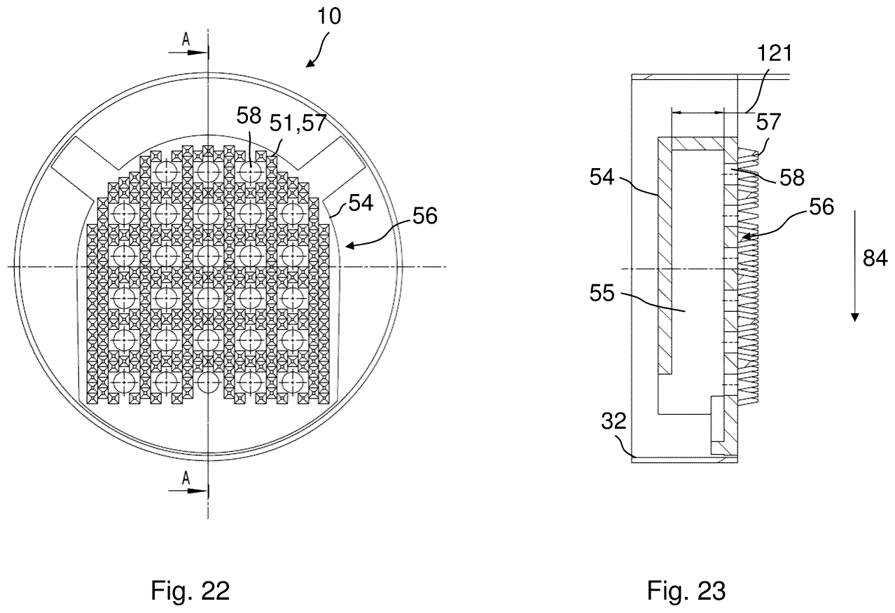

FIG. 22 shows a plan view of a separation element 50 according to a further embodiment of the invention while in FIG. 23 a section illustration of the separation element 50 along the section line A-A according to FIG. 22 is illustrated.

In this embodiment, at the front side 56 of the impactor plate 54 a plurality of passage openings 58 are arranged wherein the regions between the passage openings are covered with the structured surface 51 with elevations configured as truncated pyramids 57. The interior 55 of the impactor plate 54 is empty and forms a calmed flow zone for collection of liquid water so that the fluid flow which has entered the interior 55 may flow out again in downward direction.

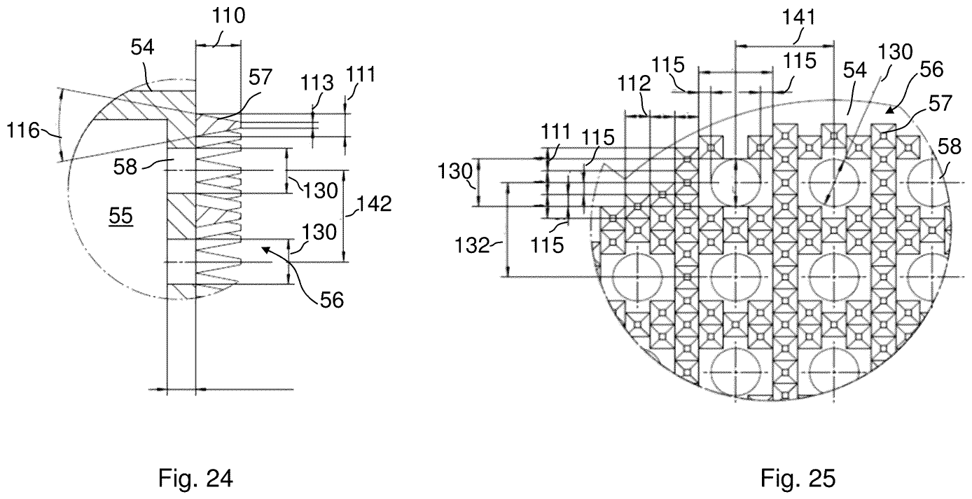

FIG. 24 shows an enlarged illustration of a detail of the section illustration according to FIG. 23 while in FIG. 25 an enlarged illustration of a detail of the plan view according to FIG. 22 is illustrated. In FIGS. 24 and 25, arrangement and measures of the separation element 50 may be seen more clearly.

The measures and spacings of the truncated pyramids 57 correspond to the measures and spacings of the embodiment illustrated in FIGS. 14 to 17. The diameter 130 of the passage openings 58 may lie between about 1 mm and about 20 mm as in the preceding embodiment and beneficially may amount to about 8 mm. A horizontal spacing 141 and a vertical spacing 142 of the passage openings 58 may lie between about 3 mm and about 30 mm and, for example, may amount to about 16 mm.

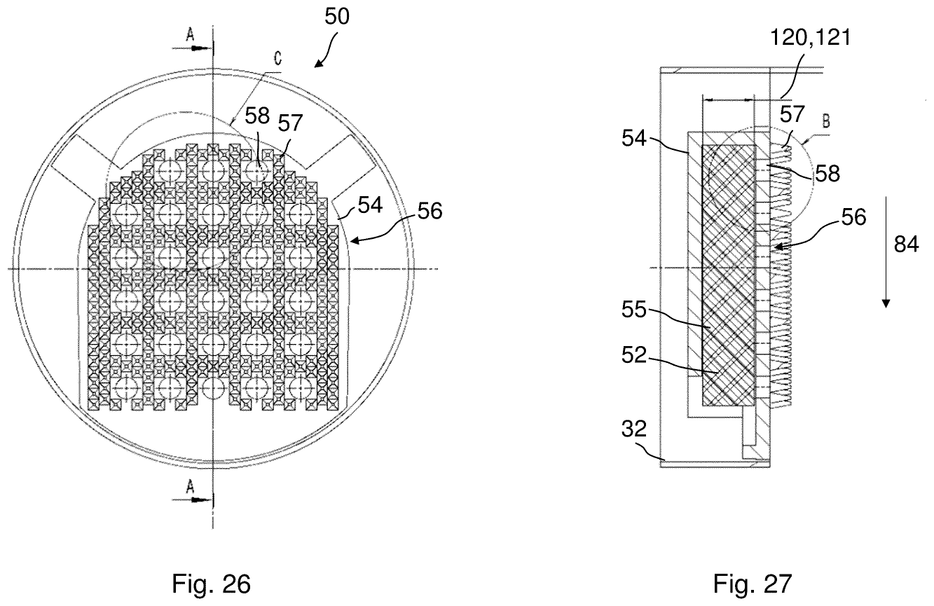

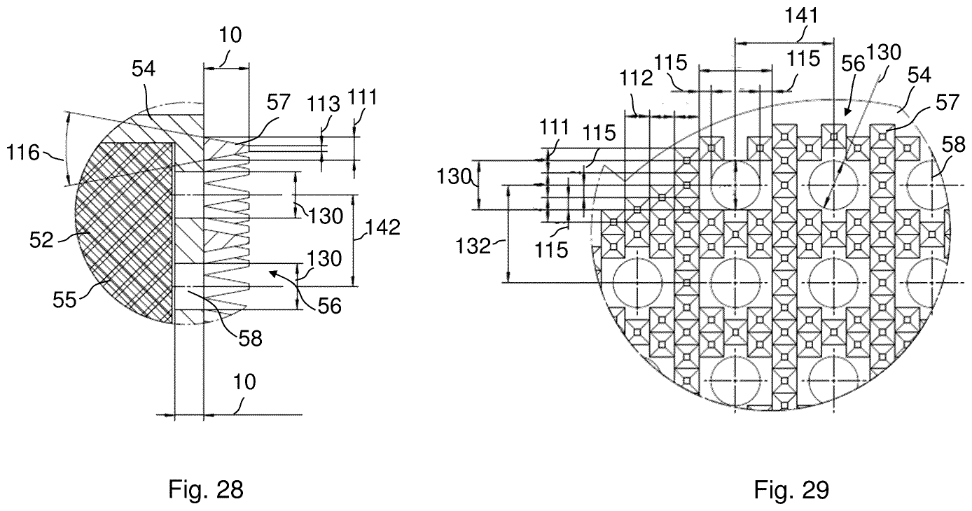

FIG. 26 shows a plan view of a separation element 50 according to a further embodiment of the invention while in FIG. 27 a section illustration of the separation element 50 along the section line A-A according to FIG. 26 is illustrated. In FIG. 28, an enlarged illustration of the detail B of the section illustration according to FIG. 27 and in FIG. 29 an enlarged illustration of the detail C of the plan view according to FIG. 26 is illustrated, respectively.

This embodiment corresponds to the embodiment illustrated in FIGS. 22 to 25 with the difference that the interior 55 of the impactor plate 54 is filled up with the nonwoven 52 in the embodiment illustrated in FIGS. 26 to 29.

In the nonwoven 52, water from the fluid flow passing through the passage openings 58 may be separated and additionally absorbed at the nonwoven 52 in this way.

The measures and spacings of truncated pyramids 57, passage openings 58, and nonwoven 52 correspond to those of the preceding embodiments.

### REFERENCE CHARACTERS

10 first separation stage
12 housing
14 inner pipe
16 outer pipe
17 fluid conduit
18 first flow-conducting region
20 coarse water separator
22 separation region
24 water outlet
26 fluid passage opening
28 end
30 second separation stage
32 housing
33 side wall outflow side
34 inlet opening
35 side wall inflow side
36 first calmed flow region
37 top side
38 second flow-conducting region
40 lamellar separator
42 outlet pipe
43 nonwoven
44 water outlet
46 inlet opening
48 collar
50 separation element
51 structured surface
52 nonwoven
53 nonwoven
54 impactor plate
55 interior
56 front side
57 truncated pyramids
58 passage opening
59 drainage channel
60 separation element
61 drainage
62 receiving pipe
64 angle
66 angle
70 baffle plate
72 inner wall
74 second calmed flow region
76 water collection chamber
78 water siphoning device
80 flow direction
82 axial direction
84 gravity direction
100 water separator
110 height
111 edge length base surface
112 edge length base surface
113 edge length end surface
114 edge length end surface
115 row offset
116 angle between lateral surfaces
120 thickness nonwoven
121 depth interior
130 diameter passage opening
131 horizontal spacing
132 vertical spacing
133 thickness nonwoven interior
134 thickness nonwoven front side
141 horizontal spacing
142 vertical spacing
143 drainage chamber
144 impactor nozzle
145 outlet pipe

What is claimed is:

1. A water separator for separating water from a fluid flow, the water separator comprising:
a first separation stage comprising a fluid conduit, a first flow-conducting region connected to the fluid conduit, and a separation region, and a water outlet,
wherein the first flow-conducting region comprises at least one inner pipe and at least one outer pipe that are arranged in an axial direction in relation to each other, the inner pipe adjoining the outer pipe and being arranged in flow direction downstream of the outer pipe,
wherein the fluid conduit comprises a coarse water separator arranged in the fluid conduit, and
wherein the separation region is arranged at a radially outer side of the inner pipe and of the outer pipe and is connected to the water outlet; and
a second separation stage comprising a second flow-conducting region, the second separation stage being arranged downstream of the first separation stage,
wherein the inner pipe of the first flow-conducting region is coupled in fluid communication to an inlet opening of the second flow-conducting region, and
wherein the second flow-conducting region comprises a first separation element that is configured to be exposed to the oncoming fluid flow, the first separation element being configured as an impactor plate with an interior open downwardly in a gravity direction, the first separation element being arranged opposite the inlet opening of the second flow-conducting region, and the impactor plate comprising a plurality of passage openings arranged in a front side of the impactor plate and for passage of the fluid flow into the interior of the impactor plate.

2. The water separator according to claim 1, wherein the first separation element comprises a nonwoven.

3. The water separator according to claim 2, wherein the nonwoven is arranged in the interior and at the front side of the impactor plate.

4. The water separator according to claim 1, wherein the second separation stage further comprises a first calmed flow region of a drainage chamber of the first separation element, the first calmed flow region being formed at a side of the first separation element facing away from the fluid flow.

5. The water separator according to claim 1, wherein the second separation stage further comprises an impactor nozzle into which the inlet opening opens, the impactor nozzle being arranged in an interior of the second flow-conducting region and being configured to guide the fluid flow against the first separation element.

6. The water separator according to claim 1, wherein the second separation stage further comprises a lamellar separator arranged transversely to the flow direction of the fluid flow in the second flow-conducting region of the second separation stage, the lamellar separator comprising a cross section corresponding to a cross section of the second flow-conducting region.

7. The water separator according to claim 1, wherein the second separation stage further comprises a first outlet pipe arranged in a region of the second flow-conducting region opposite to the gravity direction, the first outlet pipe being arranged in the second flow-conducting region diagonally opposite the inlet opening.

8. The water separator according to claim 7, wherein the first outlet pipe comprises an inlet opening and a collar arranged at the inlet opening and crimped away from the inlet opening.

9. The water separator according to claim 8, wherein the second flow-conducting region further comprises a nonwoven arranged between the collar and a side wall of the second flow-conducting region and surrounding the first outlet pipe at least in sections.

10. The water separator according to claim 9, wherein the nonwoven is formed at least in sections as part of a truncated cone, a tip of the truncated cone being oriented in a direction toward the inlet opening of the first outlet pipe.

11. The water separator according to claim 7, wherein the second flow-conducting region further comprises a baffle plate arranged opposite the first outlet pipe and transverse to the flow direction, the baffle plate being arranged at a spacing to a top side of the second flow-conducting region.

12. The water separator according to claim 1, wherein the second flow-conducting region further comprises an inner wall arranged spaced apart from a side wall of the second separation stage.

13. The water separator according to claim 12, wherein the second separation stage further comprises a second calmed flow region formed between the inner wall and the side wall.

14. The water separator according to claim 1, wherein the second separation stage further comprises a water collection chamber arranged in a part of the second flow-conducting region at a bottom in the gravity direction, the water collection chamber comprising a water outlet at a lowest point of the water collection chamber.

15. The water separator according to claim 14, wherein the second separation stage further comprises a water siphoning device arranged in the water collection chamber and connected in fluid communication to a first calmed flow region of a drainage chamber of the first separation element.

16. The water separator according to claim 1, wherein the second separation stage further comprises a receiving pipe arranged at the inlet opening of the second flow-conducting region, and a second outlet pipe arranged in an interior of the receiving pipe,
wherein a second separation element is arranged at an inner side of the receiving pipe and at least in sections surrounds the second outlet pipe,
wherein a downstream end of the second outlet pipe is at least partially closed, and
wherein the second outlet pipe comprises a plurality of fluid passage openings positioned opposite the second separation element.

17. The water separator according to claim 16, wherein the receiving pipe is arranged in the second flow-conducting region.
